(19) United States
(12) Patent Application Publication
(10) Pub. No.: US 2010/0117929 A1
(43) Pub. Date: May 13, 2010

(54) MULTI-DISPLAY SYSTEM, INFORMATION PROCESSOR, AND IMAGE DATA PROCESSING METHOD IN MULTI-DISPLAY SYSTEM

(75) Inventors: Toshiki FUJIMORI, Shimosuwa-machi (JP); Shun IMAI, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/603,158

(22) Filed: Oct. 21, 2009

(30) Foreign Application Priority Data
Nov. 10, 2008 (JP) 2008-287427
Feb. 3, 2009 (JP) 2009-022295

(51) Int. Cl. G09G 5/00

(52) U.S. Cl. 345/1.3

(57) ABSTRACT

A multi-display system includes: a plurality of image display devices; and an information processor that outputs image data to the plurality of image display devices, wherein the information processor includes a composite image data generation unit that combines partial image data to generate composite image data having a higher resolution than that of each of the image display devices, and an image data output unit that outputs the composite image data, and each of the image display devices includes an image data input unit that receives the composite image data, a partial image data generation unit that cuts out partial image data corresponding to an partial image to be displayed by the image display device from the composite image data, and an image display unit that displays the partial image based on the partial image data cut out in the partial image data generation unit.

### BACKGROUND

1. Technical Field

The present invention relates to a multi-display system, an information processor used in a multi-display system, and an image data processing method in a multi-display system.

2. Related Art

A multi-display system that arranges and displays images projected from a plurality of projection type image display devices (hereinafter referred to as projectors) on a screen and a multi-display system that displays a plurality of images simultaneously by arranging a plurality of direct-view-type image display devices have been known. In the multi-display systems, various kinds of image processing such as color correction and distortion correction have to be applied to an image to be displayed in each of the image display devices.

Especially in such a multi-display system that displays one large screen image by using a plurality of projectors, image processing has to be performed carefully on a region between adjacent images. For example, for making the seam between adjacent images inconspicuous, individual images displayed by the plurality of projectors have heretofore been displayed generally so as to have an overlapped region between adjacent images. When the display with the overlapped region is performed as described above, it is indispensable to apply a process making the overlapped region hardly visible (hereinafter referred to as edge-blending process).

In the multi-display system, various kinds of image processing including image correction are executed by a GPU (Graphic Processing Unit) mounted on a video card that functions as one hardware of a personal computer (hereinafter referred to as PC), thereby enabling higher-level image processing and the display of high quality images.

In general, image data corresponding to an. image displayed by a projector is generated by a PC, and the image data generated by the PC is transmitted to the projector. In the multi-display system including a plurality of projectors, images displayed by the individual projectors have to be generated and output by the corresponding PCs. Accordingly, in the case of using a plurality of projectors, a plurality of PCs are also required.

Video cards on which a GPU is mounted can generally provide output in two channels. Even when a special video card is used, output in eight channels is the limit at present. Accordingly, a multi-display system including over eight projectors has to use a plurality of PCs. Since the video card that can provide output in eight channels is extremely expensive, it cannot be said that the video card is generally usable.

Accordingly, when a typical video card that can provide image data output in two channels is used, one PC can simultaneously output image data to at least two projectors. However, when a multi-display system using more number of projectors than that is configured, a plurality of PCs are required.

In this manner, when a multi-display system is configured by using a number of projectors, as many PCs as corresponding to the number of projectors are required, leading to an increase in size of the multi-display system, the complexity of the configuration, and an increase in cost. For coping with this, a technique that can realize a multi-display system including a number of projectors with least number of PCs has heretofore been proposed (refer to JP-A-2006-349791, for example).

In the technique disclosed in JP-A-2006-349791 (hereinafter referred to as related-art multi-display system), for example, a PC, an image data distribution device that can distribute in parallel image data from the PC, and a plurality of image display devices (projectors) connected to the image data distribution device are provided, and individual ones of the plurality of projectors each cut out image data corresponding to an image to be displayed by itself from the image data distributed by the image data distribution device to display the same, thereby displaying one large screen image.

According to the related-art multi-display system described above, the image data distribution device and an image cut-out function provided to each of the projectors are used, whereby the multi-display system that displays a large screen image with the plurality of projectors can be realized with the least number of PCs.

In the related-art multi-display system, however, image processing that depends on the individual projectors, such as, for example, an edge-blending process on an overlapped region and correction of colors specific to the individual projectors has to be performed in the individual projectors. As described above, since the related-art multi-display system has to depend on an image data processing function provided to the individual projectors as to the various kinds of image processing that depend on the individual projectors, there arise a problem that high-level image processing can hardly be performed.

On the other hand, since higher quality is required for an image displayed in a multi-display system, higher-level image processing has to be performed. For achieving this, it is preferable that the image processing including the various kinds of correction processes be performed in a GPU on the PC side. As described above, however, a typical video card has a limitation of the number of pieces of image data to be output. As a result, even a multi-display system including a several projectors has to use a plurality of PCs at present.

### SUMMARY

An advantage of some aspects of the invention is to provide a multi-display system that can display a high-quality image, an information processor, and an image data processing method in a multi-display system by enabling a multi-display system having a number of image display devices to be realized with a small number of information processors (personal computers) and enabling even image processing including correction regarding color and correction regarding shape to be performed on the information processor side.

A multi-display system according to a first aspect of the invention includes: a plurality of image display devices; and an information processor adapted to output image data to the plurality of image display devices. The information processor includes a composite image data generation unit adapted to combine partial image data corresponding to partial images to be displayed by individual ones of the plurality of image display devices to generate composite image data having a higher resolution than that of each of the image display devices, and an image data output unit adapted to output the composite image data. Each of the image display devices includes an image data input unit adapted to receive the composite image data generated in the information processor, a partial image data generation unit adapted to cut out partial image data corresponding to an partial image to be displayed by the image display device from the composite image data, and an image display unit adapted to display the partial image based on the partial image data cut out in the partial image data generation unit.

As described above, in the multi-display system according to the first aspect of the invention, on the information processor (for example, personal computer) side, composite image data obtained by combining partial image data corresponding to partial images to be displayed by the individual image display devices is generated, and the generated composite image data is given to the individual image display devices. On the image display device side, partial image data corresponding to a partial image to be displayed by itself is cut out, and an image based on the cut-out partial image data is displayed. This makes it possible to output a plurality of pieces of partial image data to be given to a plurality of image display devices from the information processor to the individual image display devices as one piece of image data (composite image data). Therefore, the multi-display system including a number of image display devices can be realized with a small number of information processors.

The multi-display system according to the first aspect of the invention can perform not only composite image data generation processing but also image processing including various kinds of correction processes on the information processor side. As described above, in the multi-display system according to the first aspect of the invention, the image processing including image correction that has heretofore been performed in each of the image display devices can be performed on the information processor side. Therefore, it is possible to perform high-level image processing and to thereby make an image displayed in the multi-display system of high quality.

In the first and other aspects of the invention, the “partial image(s)” means an individual image(s) displayed by an individual image display device(s). The “partial image” is not only an individual one of a plurality of images in the case where a plurality of images that are related to one another are arranged to form one large screen image but also an individual one of a plurality of images in the case where a plurality of images that are not related to one another are arranged to be displayed.

It is preferable that the information processor include a video card, and that the video card functions as the composite image data generation unit and the image data output unit.

This makes it possible to perform image processing including various kinds of image corrections with a GPU mounted on the video card, enabling high-level image processing. Since even a typical video card has an image data output function in two channels, image data corresponding to at least two image display devices can be output by using only one video card. By using two video cards, image data corresponding to at least four image display devices can be output.

Capability of processing of image data per output channel of the video card in terms of how many projectors the image data corresponds to depends on the resolution of the projector used in the multi-display system, processing ability for image data of the information processor side (video card side) and the like. Therefore, each output channel can output image data corresponding to, for example, four image display devices in some cases. This makes it possible to realize the multi-display system including a number of image display devices with a small number of information processors. The video card may be incorporated into the information processor or may be externally attached to the information processor.

It is preferable that the respective resolutions in horizontal and vertical directions of the composite image data be set to integral multiples of the resolutions in horizontal and vertical directions of each of the image display devices.

As described above, the respective resolutions in horizontal and vertical directions of the composite image data are set to integral multiples of the resolutions in horizontal and vertical directions of each of the image display devices. Therefore, when the multi-display system is configured with, for example, a plurality of image display devices disposed in each of the horizontal and vertical directions, image data having the resolution of each of the image display devices can be cut out as it is, eliminating the necessity of performing a scaling process and the like in each of the image display devices.

It is preferable that the multi-display system further include an image data distribution device adapted to distribute in parallel the composite image data output from the information processor to the individual image display devices.

This makes it possible to distribute in parallel composite image data generated on the information processor side to the plurality of image display devices.

It is preferable that the information processor apply image processing including image correction to the partial image data.

As described above, the image processing including various kinds of image corrections, which has heretofore been performed in each of the image display devices, is performed on the information processor side. Therefore, it is possible to perform high-level image processing.

it is preferable that the image correction applied to the partial image data include image correction based on individual difference among the plurality of image display devices.

As described above, the image correction based on individual difference among the image display devices, which has heretofore been performed in each of the image display devices, is performed on the information processor side. Therefore, it is possible to perform high-level correction and to thereby make an image displayed in the multi-display system of high quality. The correction can be realized by giving correction parameters necessary for performing the correction to an image data processing device of the information processor.

It is preferable that the image correction based on the individual difference be correction regarding color.

As the correction regarding color, a process for correcting color difference due to individual difference among the individual image display devices or a process for correcting color non-uniformities specific to the individual image display devices can be exemplified. The correction regarding color is performed on the information processor side, whereby it is possible to perform high-level correction.

It is preferable that the plurality of image display devices be a plurality of projectors, and that the plurality of projectors be disposed such that partial images displayed by the individual projectors are displayed in a state of being arranged on a screen.

According to the first aspect of the invention, it is possible to realize the multi-display system including a number of projectors with a small number of information processors. In addition, the composite image data generation processing and the image processing including a correction process can be performed on the information processor side. Therefore, it is possible to perform high-level image processing and to thereby make an image displayed in the multi-display system of high quality.

It is preferable that the information processor perform correction regarding shape of partial images to be displayed by the individual projectors on partial image data corresponding to the partial images.

As described above, the correction regarding shape that has heretofore been performed in each of the projectors is performed on the information processor side. Therefore, it is possible to perform high-level correction and to thereby make an image displayed in the multi-display system of high quality. The correction can be realized by giving correction parameters necessary for performing the correction to the image data processing device of the information processor.

It is preferable that the correction regarding shape of the partial images include at least one of correction of display size of partial images to be displayed by the individual projectors and distortion correction of the partial images to be displayed by the individual projectors.

This makes it possible to uniform the size of an image displayed by each of the projectors and correct non-linear distortion due to lens distortion or the like.

It is preferable that the information processor perform keystone correction on an entire image to be displayed on a screen.

This corrects trapezoidal distortion caused by a projection angle of each of the projectors with respect to a screen. A display image on a screen can be made in a rectangular shape by performing the keystone correction.

It is preferable that the keystone correction be performed by correcting respective trapezoidal distortions of partial images displayed by the individual projectors by using correction parameters corresponding to the partial images displayed by the individual projectors.

This performs the correction on partial image data corresponding to partial images to be displayed by the individual projectors by using correction parameters given to the respective partial images to be displayed by the individual projectors when performing the keystone correction. This makes it possible to perform the correction in accordance with the degree of distortion of partial images to be displayed by the individual projectors and to thereby properly make an image displayed on a screen rectangular.

It is preferable that the partial images displayed by the individual projectors be related to one another, and that the partial images that are related to one another form one large screen image.

This is the case of a multi-display system that forms one large screen image with partial images that are related to one another. In the case of such a multi-display system, image data corresponding to one large screen image is divided into partial image data corresponding to the individual projectors, predetermined image processing such as image correction is applied to the divided partial image data, and composite image data obtained by combining the image-processed partial image is given to the individual projectors. By performing the process, it is possible to configure the multi-display system that forms one large screen image with partial images that are related to one another.

It is preferable that the partial images displayed by the individual projectors be displayed so as to each have an overlapped region between adjacent images, and that the information processor generate partial image data while considering the overlapped region for each of the projectors and generate composite image data obtained by combining the partial image data.

This makes it possible to cut out partial image data including the overlapped region in each of the projectors when cutting out partial image data to be displayed by itself.

It is preferable that an edge-blending process is applied to the overlapped regions in the composite image data obtained by combining the partial image data.

The edge-blending process is a process for making the overlapped region hardly visible. In the multi-display system according to the first aspect of the invention, the edge-blending process is performed in the image data processing device of the information processor. Since the edge-blending process is performed on the information processor side, the edge-blending process does not have to be performed on each of the projector sides. In addition, the edge-blending process can be performed with high accuracy.

An information processor according to a second aspect of the invention is an information processor in a multi-display system including a plurality of image display devices and the information processor adapted to output image data to the plurality of image display devices. The information processor includes a composite image data generation unit adapted to combine partial image data corresponding to partial images to be displayed by individual ones of the plurality of image display devices to generate composite image data having a higher resolution than that of each of the image display devices and an image data output unit adapted to output the composite image data.

By using the information processor, the multi-display system according to the first aspect of the invention can be configured. It is preferable that also the information processor according to the second aspect of the invention have the features of the multi-display system according to the first aspect of the invention.

A method for processing image data in a multi-display system according to a third aspect of the invention is a method for processing image data in a multi-display system including a plurality of image display devices and an information processor adapted to output image data corresponding to images to be displayed by individual ones of the plurality of image display devices. The method includes: combining, by the information processor, partial image data corresponding to partial images to be displayed by the individual ones of the plurality of image display devices to generate composite image data having a higher resolution than that of each of the image display devices; outputting, by the information processor, the composite image data; receiving, by each of the image display devices, the composite image data generated by the information processor; cutting out, by each of the image display devices, partial image data corresponding to a partial image to be displayed by the image display device from the composite image data; and displaying, by each of the image display devices, the partial image based on the cut-out partial image data.

The above-described steps are executed in the information processor and each of the image display devices, whereby an effect similar to that of the multi-display system according to the first aspect of the invention can be provided. It is preferable that also the method for processing image data in the multi-display system according to the third aspect of the invention has the features of the multi-display system according to the first aspect of the invention.

### BRIEF DESCRIPTION OF THE DRAWINGS

The invention will now be described with reference to the accompanying drawings, wherein like numbers reference like elements.

FIG. 1 shows the configuration of a multi-display system according to an embodiment.

FIG. 2 is a functional block diagram of the multi-display system according to the embodiment.

FIG. 3 explains an image cut-out function provided to each of projectors.

FIG. 4 explains the case where four images that are not related to one another are arranged to be displayed on a screen.

FIG. 5 explains the case where four partial images that are related to one another are displayed on a screen as one large screen image.

FIGS. 6A to 6D explain an example of correcting display size.

FIGS. 7A to 7C explain an example of correcting non-linear distortion.

FIGS. 8A to 8C explain an example of performing keystone correction.

### DESCRIPTION OF EXEMPLARY EMBODIMENT

Hereinafter, an embodiment of the invention will be described.

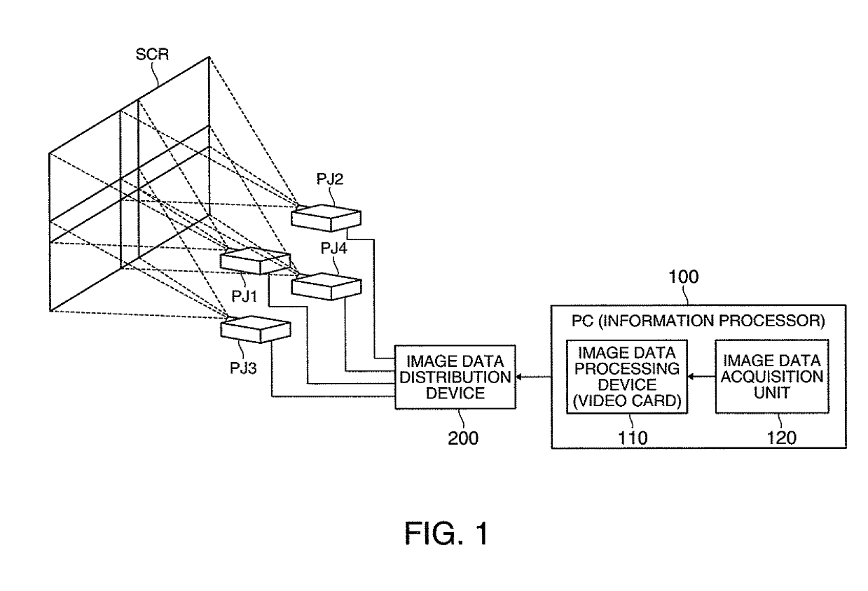

FIG. 1 shows the configuration of a multi-display system according to the embodiment. As shown in FIG. 1, the multi-display system according to the embodiment includes a personal computer (hereinafter referred to as PC) 100 as an information processor having a video card 110 as an image data processing device and an image data acquisition unit 120 that acquires image data to be displayed, a plurality (two in each of horizontal and vertical directions, that is, four in total) of projectors PJ1 to PJ4, and an image data distribution device 200 that distributes image data output from the PC 100 to each of the projectors PJ1 to PJ4.

FIG. 1 shows an example in which individual images (hereinafter referred to as partial images) displayed by the individual projectors PJ1 to PJ4 are displayed so as to each have an overlapped region between adjacent partial images. However, the embodiment can be applied to the case where the individual images are displayed so as not to have the overlapped region.

Image data acquired by the image data acquisition unit 120 may be image data (moving image or still image) generated on the PC 100 or may be image data generated externally and loaded into the PC 100.

Each of the projectors PJ1 to PJ4 has an image data cut-out function that cuts out partial image data corresponding to a partial image to be displayed by itself from image data that is distributed by the image data distribution device 200. It is assumed that each of the projectors PJ1 to PJ4 has a resolution of XGA (1024×768 pixels).

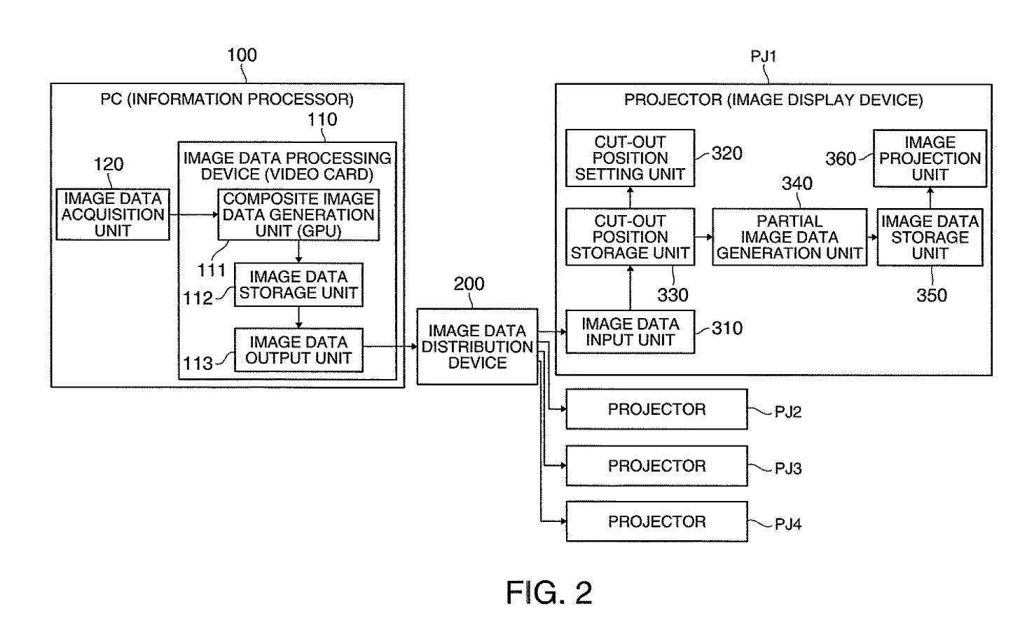

FIG. 2 is a functional block diagram of the multi-display system according to the embodiment. As shown in FIG. 2, the video card 110 provided in the PC 100 includes a composite image data generation unit 111 that applies predetermined image processing including image correction to partial image data corresponding to partial images to be displayed individually by the projectors PJ1 to PJ4 and combines the partial image data to generate composite image data having a higher resolution than that of each of the projectors, an image data storage unit 112 that stores image data generated in the composite image data generation unit 111 (hereinafter referred to as composite image data), and an image data output unit 113 that outputs the composite image data. The composite image data generation unit 111 performs processing as one of functions of a GPU mounted on the video card 110. The content of the processing will be described later.

The resolutions (resolution in the horizontal direction and resolution in the vertical direction) of composite image data generated in the composite image data generation unit 111 are preferably set to integral multiples of resolutions in the horizontal and vertical directions of each of the projectors. In the multi-display system according to the embodiment, integers used in the integral multiple are defined as the numbers of projectors in the horizontal and vertical directions.

That is, when the resolution of each of the projectors in the horizontal direction is M, and the number of projectors in the horizontal direction is a, the resolution of composite image data in the horizontal direction is “M×a”. While, when the resolution of each of the projectors in the vertical direction is N, and the number of projectors in the vertical direction is b, the resolution of composite image data in the vertical direction is “N×b”. Specifically, in the multi-display system according to the embodiment, the resolution of each of the projectors in the horizontal direction is 1024 pixels, the resolution in the vertical direction is 768 pixels, and two projectors are disposed in each of the horizontal and vertical directions. Therefore, the resolution of composite image data in the horizontal direction is 2048 pixels, and the resolution in the vertical direction is 1536 pixels.

The image data distribution device 200 distributes in parallel composite image data output from the image data output unit 113 of the PC 100 to the projectors PJ1 to PJ4. The composite image data distributed from the image data distribution device 200 to the projectors PJ1 to PJ4 is image data corresponding to an entire image displayed on a screen SCR.

Each of the projectors PJ1 to PJ4 includes an image data input unit 310 that receives composite image data distributed from the image data distribution device 200, a cut-out position setting unit 320 that sets cut-out positions of an image to be displayed by itself, a cut-out position storage unit 330 that holds the cut-out positions set in the cut-out position setting unit 320, a partial image data generation unit 340 that cuts out the composite image data input to the image data input unit 310 based on the cut-out positions held in the cut-out position storage unit 330 and generates partial image data corresponding to a partial image to be displayed by itself, an image data storage unit 350 that holds the partial image data generated in the partial image data generation unit 340, and an image projection unit 360 as an image display unit that generates a partial image based on the partial image data held in the image data storage unit 350 to project the generated partial image on the screen SCR.

The image projection unit 360 includes known constituent elements such as a light source, a light modulation device, an optical system for introducing light from the light source to the light modulation device, and a projection optical system for projecting an image generated by the light modulation device that are provided in a typical projector, and therefore the detailed description of the image projection unit 360 is omitted.

Although only the configuration of the projector PJ1 is shown in FIG. 2, the projectors PJ2 to PJ4 each have the same configuration.

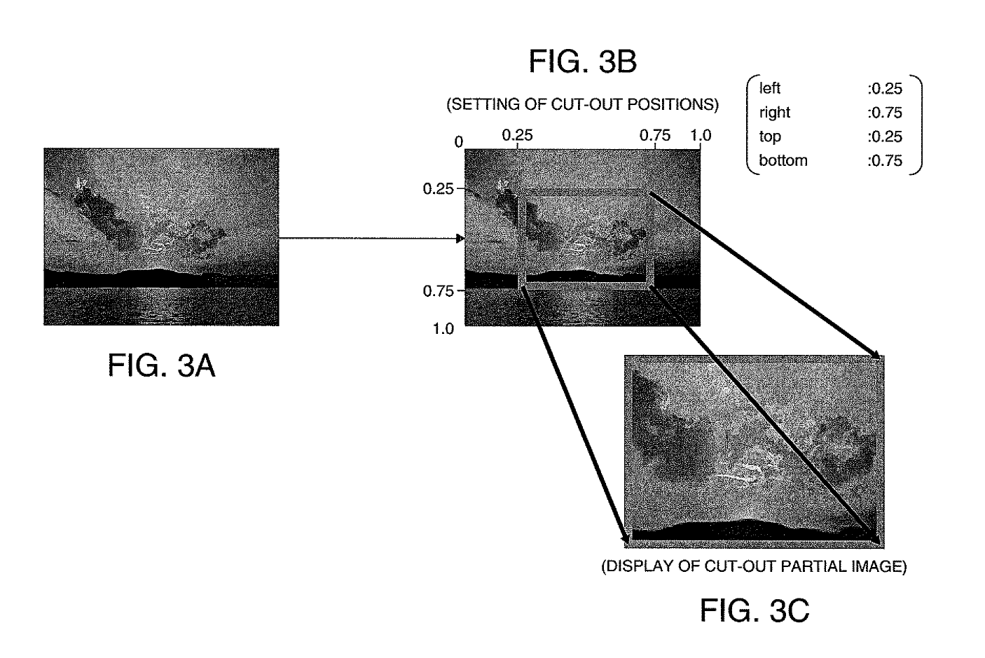

FIG. 3 explains an image cut-out function provided to each of the projectors. It is assumed that part (a) of FIG. 3 is an image (composite image) corresponding to composite image data distributed by the image data distribution device 200. Part (b) of FIG. 3 shows an example of setting cut-out positions when an partial image is cut out in one projector (projector PJ1). Part (c) of FIG. 3 shows an example of displaying a cut-out partial image.

As shown in FIG. 3, in the projector PJ1, based on cut-out positions (cut-out positions held in the cut-out position storage unit 330) set by the cut-out position setting unit 320, the partial image data generation unit 340 cuts out partial image data from composite image data. After performing a process (scaling process) for adjusting the resolution of the cut-out partial image data to its own resolution and the like on the cut-out partial image data, the projector PJ1 projects a partial image based on the cut-out partial image data with the image projection unit 360. The scaling process does not have to be performed when the resolution of the cut-out partial image data is the same as its own resolution.

In the example shown in FIG. 3, when an upper left end position, a right end position on the upper end side, and a lower end position on the left end side of the composite image are “0”, “1.0”, and “1.0”, respectively, cut-out positions set in the projector PJ1 are set to “0.25” for a left side cut-out position (left), “0.75” for a right side cut-out position (right), “0.25” for an upper side cut-out position (top), and “0.75” for a lower side (bottom side) cut-out position (bottom).

Next, composite image data generation processing in the PC 100 will be described. In the multi-display system according to the embodiment, two of the four projectors PJ1 to PJ4 are disposed in the horizontal direction, the remaining two are disposed in the vertical direction, and the resolution of each of the projectors PJ1 to PJ4 is 1024×768 pixels. Therefore, composite image data in which image data each configured by 1024×768 pixels are combined for four screens is generated by the PC 100. That is, the PC 100 generates composite image data having a resolution of 2048×1536 pixels.

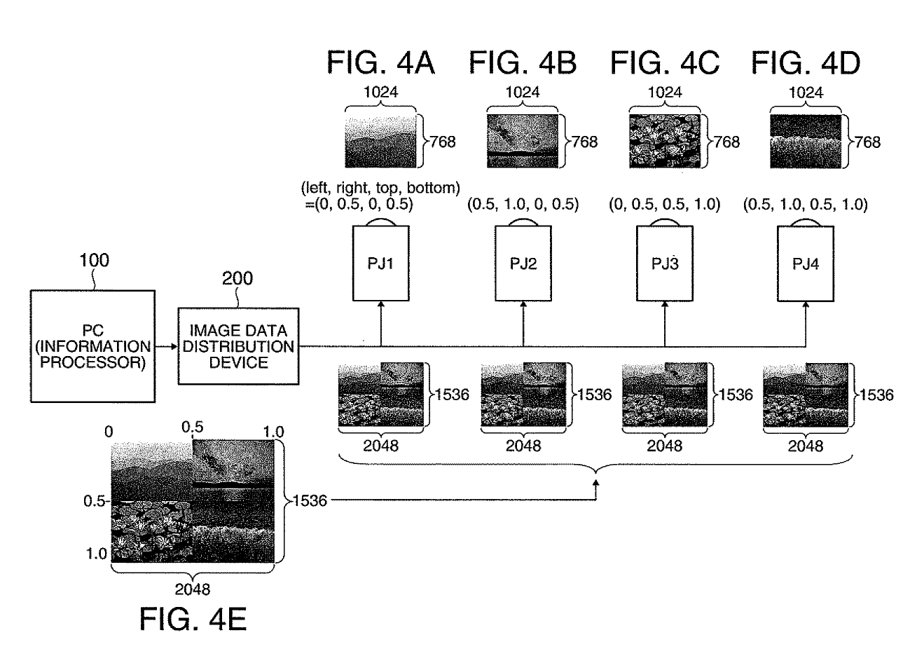

FIG. 4 explains the case where four partial images that are not related to one another are arranged and displayed on a screen. In this case, the PC 100 combines partial image data respectively corresponding to the four partial images that are not related to one another to thereby generate one piece of composite image data and outputs the generated composite image data from one output channel of the video card 110 to the image data distribution device 200. The composite image data is distributed in parallel from the image data distribution device 200 to each of the projectors PJ1 to PJ4.

Parts (a) to (d) of FIG. 4 are partial images to be displayed respectively by the projectors PJ1 to PJ4. The PC 100 acquires image data corresponding to the partial images shown in the parts (a) to (d) of FIG. 4 with the image data acquisition unit 120 and generates composite image data by combining the acquired image data (partial image data) (refer to part (e) of FIG. 4). In this case, the resolution of the composite image data in the horizontal direction is set to be twice (1024×2=2048 pixels) that of each of the projectors in the horizontal direction, and the resolution of the composite image data in the vertical direction is also set to be twice (768×2=1536 pixels) that of each of the projectors in the vertical direction.

The combining of image data is performed by the composite image data generation unit 111 of the video card 110. The generated composite image data is held in the image data storage unit 112. Thereafter, the image data output unit 113 outputs the generated composite image data as one piece of image data from one output channel to the image data distribution device 200. The image data distribution device 200 distributes the composite image data to each of the projectors PJ1 to PJ4.

In the projectors PJ1 to PJ4, on the other hand, the composite image data distributed from the image data distribution device 200 is input to the image data input unit 310. Each of the projectors PJ1 to PJ4 cuts out partial image data to be displayed by itself from the composite image data based on the cut-out positions set in the cut-out position setting unit 320. As described in FIG. 3, the cutting out of the partial image data is performed based on the cut-out positions set in the respective projectors PJ1 to PJ4, that is, the left side cut-out position (left), the right side cut-out position (right), the upper side cut-out position (top), and the lower side (bottom side) cut-out position (bottom).

For example, in the projector PJ1, the cut-out positions (left, right, top, and bottom) are respectively set to (0, 0.5, 0, and 0.5). Therefore, the projector PJ1 cuts out partial image data based on the cut-out positions so that partial image data corresponding to a partial image to be displayed by itself is cut out. In the same manner, the projectors PJ2 to PJ4 cut out partial image data based on cut-out positions respectively set therein.

The image projection unit 360 of each of the projectors PJ1 to PJ4 generates a partial image based on the partial image data cut out by itself to thereby display the partial image on the screen SCR. Therefore, the partial images shown in the parts (a) to (d) of FIG. 4 are displayed (tiled) on the screen SCR in a state where two partial images are arranged in each of the horizontal and vertical directions. That is, the image shown in the part (e) of FIG. 4 is displayed on the screen SCR.

Although FIG. 4 shows the case of displaying the four partial images that are not related to one another, the invention can be applied to the case where four partial images that are related to one another are displayed on a screen as one large screen image.

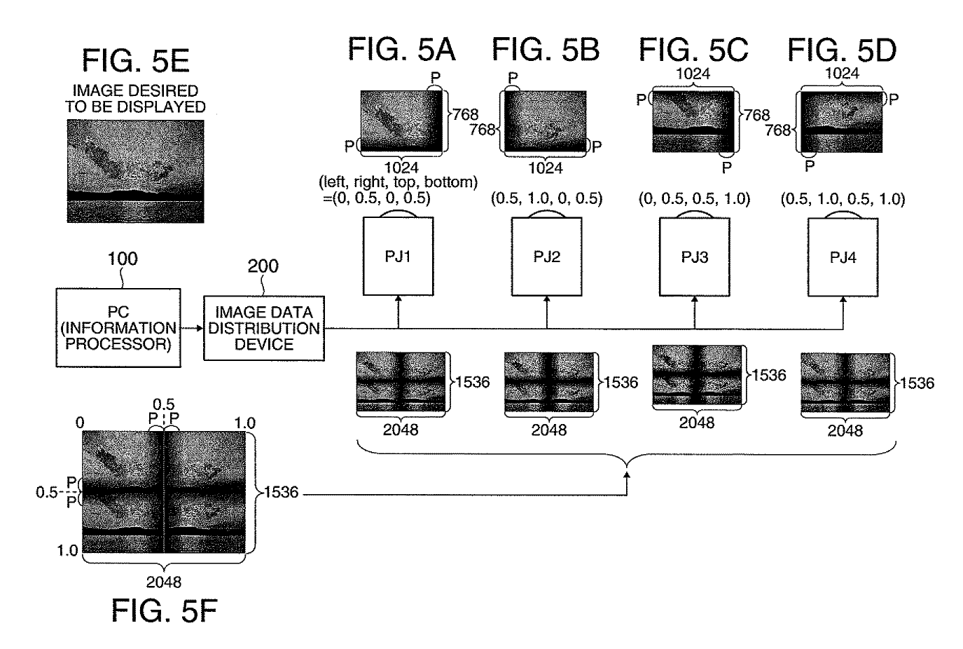

FIG. 5 explains the case where four partial images that are related to one another are displayed on a screen as one large screen image. In FIG. 5, the individual partial images displayed by the projectors PJ1 to PJ4 are displayed so as to each have an overlapped region between adjacent partial images.

Parts (a) to (d) of FIG. 5 are partial images to be displayed respectively by the projectors PJ1 to PJ4. An edge blending process is applied to overlapped regions P.

Part (e) of FIG. 5 is a large screen image to be displayed on the screen SCR. This is an image in which the four partial images shown in the parts (a) to (d) of FIG. 5 are tiled so as to each have the overlapped region between adjacent partial images.

For tiling partial images as shown in FIG. 5, in the PC 100, various kinds of image processing such as the edge-blending process on the overlapped regions p are applied to partial image data corresponding to the partial images to be displayed by the projectors PJ1 to PJ4, and thereafter composite image data obtained by combining the partial image data is generated (refer to part (f) of FIG. 5).

The edge-blending process and the combining process for combining the partial image data can be performed by the composite image data generation unit 111. The composite image data (composite image data applied with the edge-blending process) generated in the composite image data generation unit 111 is written to the image data storage unit 112. Since pixels present in the overlapped region p are common between adjacent projectors, image data of the same pixels is redundantly written to the image data storage unit 112.

The image data output unit 113 outputs the composite image data written to the image data storage unit 112 from one output channel to the image data distribution device 200. The image data distribution device 200 distributes the composite image data corresponding to the composite image shown in the part (f) of FIG. 5 to the projectors PJ1 to PJ4.

In the projectors PJ1 to PJ4, on the other hand, the composite image data distributed from the image data distribution device 200 is input to the image data input unit 310, and partial image data corresponding to a partial image to be displayed by itself is cut out based on the respective cut-out positions set in the projectors PJ1 to PJ4.

In the projector PJ1 in this case, since the cut-out positions (left, right, top, and bottom) are respectively set to (0, 0.5, 0, and 0.5), partial image data is cut out based on the set cut-out positions. In the same manner, in each of the projectors PJ2 to PJ4, partial image data is cut out based on the set cut-out positions. Based on the cut-out partial image data, the image projection units 360 of the projectors PJ1 to PJ4 respectively project the partial images shown in the parts (a) to (d) of FIG. 5. The edge-blending process is applied to the overlapped regions P in the partial images shown in the parts (a) to (d) of FIG. 5. Therefore, the overlapped regions P between adjacent partial images are overlapped with each other to thereby form an image whose overlapped regions are hardly visible on the screen SCR (refer to the part (e) of FIG. 5).

In addition, a color correction process for correcting color difference among partial images due to individual difference in color among the projectors PJ1 to PJ4 and correction of color non-uniformities specific to the projectors PJ1 to PJ4 can be applied to the partial image data in the composite image data generation unit 111 of the video card 110 by giving correction parameters for performing the corrections to the PC 100.

Composite image data obtained by combining the correction-processed partial image data is given to the projectors PJ1 to PJ4, whereby the projectors PJ1 to PJ4 can cut out the corrected partial image data from the composite image data. In the embodiment of the invention, the correction for correcting the color difference among the partial images and the correction of the color non-uniformities are collectively hereinafter referred to as “correction regarding color”.

The correction regarding color can be performed not only in the case where four partial images that are related to one another are displayed on a screen as one large screen image (refer to FIG. 5) but also in the case where four partial images that are not related to one another are arranged and displayed on a screen in the same manner (refer to FIG. 4).

In the composite image data generation unit 111, correction of the relative size (hereinafter referred to as display size) of a partial image displayed by each of the projectors and distortion correction of the partial image are possible in addition to the correction regarding color. Especially when the partial images displayed by the projectors are different in display size, or when the image is distorted, the overlapped region between adjacent images cannot be set accurately. As a result, the edge-blending process cannot be performed properly. Therefore, it is important to properly perform the display size correction or the distortion correction of image on the partial image displayed by each of the projectors. In the embodiment of the invention, the display size correction of partial image and the distortion correction of image are collectively hereinafter referred to as “correction regarding shape”.

In the same manner as in the correction regarding color, the composite image data generation unit 111 of the video card 110 in the PC 100 can apply the correction regarding shape to the partial image data by giving correction parameters for performing the correction regarding shape to the PC 100 side.

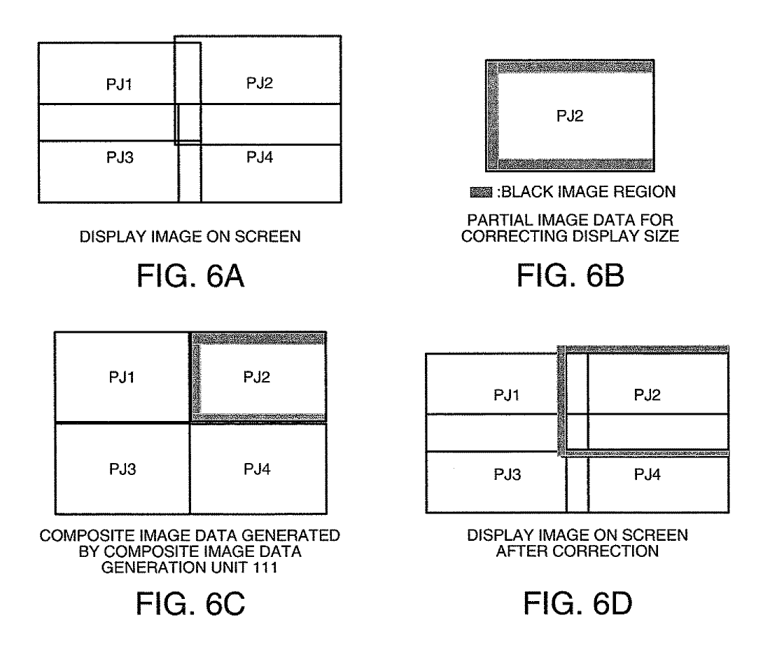

FIGS. 6A to 6D explain an example of correcting the display size. FIG. 6A schematically shows a state where partial images from the projectors PJ1 to PJ4 are tiled on the screen SCR so as to each have an overlapped region between adjacent partial images.

For tiling the partial images so as to have the overlapped region between adjacent partial images, the composite image data generation unit 111 of the PC 100 applies the various kinds of image processing such as the edge-blending process on the overlapped regions to the partial image data corresponding to the partial images to be displayed by the projectors PJ1 to PJ4, and thereafter generates composite image data obtained by combining the partial image data as described in FIG. 5. Based on the thus generated composite image data, each of the projectors PJ1 to PJ4 cuts out the partial image data to be displayed by itself to display the same.

In this case, as shown in FIG. 6A, it is assumed that the partial image displayed by the projector PJ2 has a relatively large display size compared with the partial images of the projectors PJ1 and PJ2. As shown in FIG. 6A, when the images displayed by the projectors are different in display size, the overlapped regions are not uniform between adjacent images. Therefore, when the edge-blending process is performed, the edge-blending process cannot be performed properly.

Accordingly, the composite image data generation unit 111 generates partial image data for correcting the display size (hereinafter referred to as partial image data for correcting display size) for the partial image data corresponding to the projector PJ2 (refer to FIG. 6B). The gray region in FIG. 6B is a black image region.

That is, considering that the partial image of the projector PJ2 is larger in display size than the partial images of the other projectors, the composite image data generation unit 111 generates partial image data with a black image region (partial image data for correcting display size) is generated as partial image data corresponding to the projector PJ2.

The partial image data for correcting display size is obtained by reducing the partial image data before correction so that the partial image displayed on the screen SCR has a size to be displayed and making a portion not to be displayed a black image region. Correction parameters (such as positional data for setting the black image region) for generating the partial image data for correcting display size shown in FIG. 6B can be set based on picked-up image data obtained by, for example, picking-up an image displayed on the screen SCR with image pick-up means (not shown).

FIG. 6C schematically shows composite image data obtained by combining partial image data corresponding to the projectors PJ1 to PJ4, in which the partial image data corresponding to the projector PJ2 is partial image data with a black image region (partial image data for correcting display size). It is assumed that the edge-blending process is applied to the partial image data forming the composite image data shown in FIG. 6C.

When the composite image data shown in FIG. 6C is given to each of the projectors PJ1 to PJ4, each of the projectors PJ1 to PJ4 cuts out partial image data to be displayed by itself to display the same. In this case, in the projector PJ2, since a partial image is displayed by using the partial image data for correcting display size, the partial image displayed by the projector PJ2 has the same display size as those of the other projectors. Therefore, the respective partial images displayed by the projectors PJ1 to PJ4 are displayed in the same display size (refer to FIG. 6D).

When the display shown in FIG. 6D is performed, the black image region appears as black floating. For eliminating the black floating, a light shielding plate is disposed corresponding to the black image region, whereby it is possible to make the black floating inconspicuous.

Non-linear distortion due to lens distortion or the like can also be corrected in addition to the correction of the simple linear shape shown in FIGS. 6A to 6D.

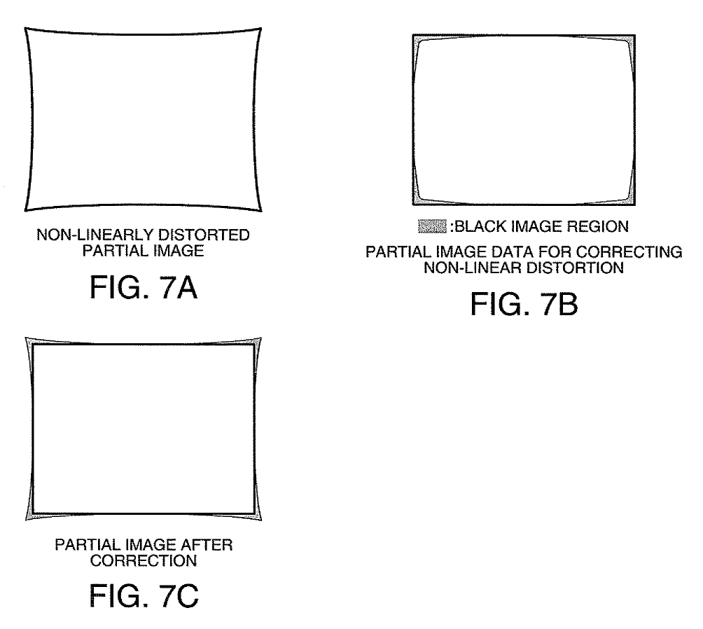

FIGS. 7A to 7C explain an example of correcting non-linear distortion. FIGS. 7A to 7C show partial images displayed by one projector. FIG. 7A shows a partial image including non-linear distortion (hereinafter referred to as non-linearly distorted partial image) due to lens distortion or the like. FIG. 7B schematically shows partial image data for correcting the non-linearly distorted partial image (hereinafter referred to as partial image data for correcting non-linear distortion) shown in FIG. 7A.

The partial image data for correcting non-linear distortion is obtained by correcting partial image data before correction so that a partial image to be displayed on the screen SCR becomes a rectangular partial image from which the distortion is removed. The partial image data for correcting non-linear distortion shown in FIG. 7B is given to the projector, whereby the non-linearly distorted partial image shown in FIG. 7A is made into a rectangular partial image from which the distortion is removed as shown by the bold line in FIG. 7C.

In this manner, non-linear distortion can be removed by performing the correction shown in FIGS. 7A to 7C on a non-linearly distorted partial image. When the partial images in the projectors PJ1 to PJ4 are different in display size, after performing the non-linear distortion correction shown in FIGS. 7A to 7C, the display size correction described in FIGS. 6A to 6D may be performed.

When trapezoidal distortion based on the projection angle of each of the projectors PJ1 to PJ4 with respect to a screen occurs in an entire image (for example, refer to the part (e) of FIG. 5) displayed by the projectors PJ1 to PJ4, it is also possible to perform correction for correcting the trapezoidal distortion (keystone correction).

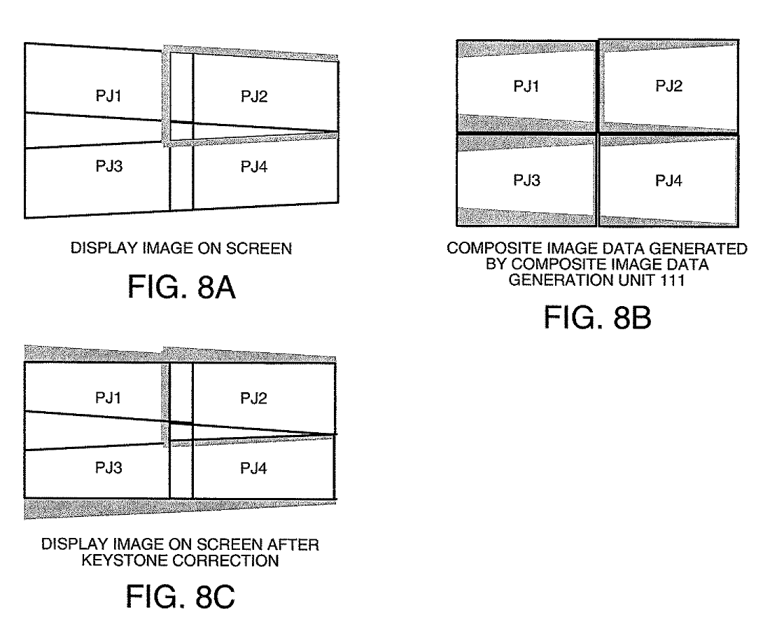

FIGS. 8A to 8C explain an example of performing the keystone correction. It is assumed in FIGS. 8A to 8C that partial image data corresponding to the partial image to be displayed by the projector PJ2 is the partial image data for correcting display size.

FIG. 8A shows a state where trapezoidal distortion occurs in an entire image displayed by the projectors PJ1 to PJ4 on the screen SCR, in which the gray region is a black image region in the partial image of the projector PJ2.

When the trapezoidal distortion shown in FIG. 8A occurs in the entire image displayed by the projectors PJ1 to PJ4 on the screen SCR, the composite image data generation unit 111 generates correction parameters different for each of partial images to be displayed by the individual projectors. The composite image data generation unit 111 generates partial image data for correcting the trapezoidal distortions (hereinafter referred to as partial image data for correcting trapezoidal distortion) of the respective partial images by using the correction parameters for the respective partial images and generates composite image data obtained by combining the partial image data for correcting trapezoidal distortion generated for the respective partial images. The partial image data for correcting trapezoidal distortion is obtained by correcting partial image data before correction so that the partial image to be displayed on the screen SCR is made into a keystone-corrected image.

FIG. 8B schematically shows composite image data generated by the composite image data generation unit 111. In FIG. 8B, the gray region is a black image region. When the composite image data is given to each of the projectors PJ1 to PJ4, each of the projectors PJ1 to PJ4 cuts out a partial image to be displayed by itself from the composite image data given by the PC 100 to display the same. Therefore, the keystone-corrected image is displayed on the screen SCR as shown in FIG. 8C.

The correction parameters for performing the display size correction and the distortion correction described in FIGS. 6A to 6D and FIGS. 7A to 7C and the correction parameters for performing the keystone correction described in FIGS. 8A to 8C can be automatically generated based on picked-up image data obtained by picking up an image on a screen using image pick-up means. However, a user may manually generate the correction parameters.

When performing both the display size correction and/or distortion correction and the keystone correction shown in FIGS. 8A to 8C, the order of the corrections may be set in advance such that, for example, after performing the display size correction and/or distortion correction, the keystone correction is performed. Alternatively, these corrections may be combined into one computation.

As described above, in the multi-display system according to the embodiment, the composite image data generation unit 111 of the video card 110 provided in the PC 100 applies various kinds of image processing such as the edge-blending process, the correction regarding color, and the correction regarding shape to partial image data corresponding to the partial images displayed by the projectors PJ1 to PJ4 and combines them, thereby generating composite image data having a higher resolution than that of each of the projectors. Then, the image data output unit 113 of the video card 110 outputs the generated composite image data to the image data distribution device 200.

In this manner, in the multi-display system according to the embodiment, four pieces of image data (four pieces of partial image data) to be given to the four projectors PJ1 to PJ4 are combined together to be output as one piece of image data (one piece of composite image data). This makes it possible to output image data to be given to the four projectors PJ1 to PJ4 with one PC by using only one output channel of a typical video card having two output channels.

Accordingly, when using the two output channels of the typical video card, image data corresponding to eight projectors can be generated and output with one PC. Further, if it is possible to use an expensive video card that can provide eight output channels, one PC can generate and output image data corresponding to 32 projectors when each output channel can output four projectors worth of image data.

Capability of processing of image data per output channel of the video card 110 in terms of how many projectors the image data corresponds to depends on the resolution of the projector used in the multi-display system, processing ability for image data of the PC side (video card side) and the like. A current typical PC (video card) can sufficiently perform image data generation and output processing corresponding to four projectors for each output channel when the resolution of a projector is XGA (1024×768 pixels). Further, it is conceivable that the PC can sufficiently cope with the resolution of the so-called full high vision standard (1920×1080 pixels) frequently employed for home-use projectors or the like in recent years.

In the multi-display system according to the embodiment, a GPU mounted on a video card applies image processing including image corrections such as the correction regarding color and the correction regarding shape. Therefore, high-level image processing is possible compared with the case where the image processing is applied in a projector, providing an effect that an image to be displayed can be of high quality.

Many of typical PCs have a video card that can realize the multi-display system according to the embodiment. In addition, projectors generally have an image cut-out function. Therefore, when realizing the multi-display system according to the embodiment, there is no need to provide a special hardware to the PC and projector, and therefore the multi-display system can be configured inexpensively.

The invention is not limited to the above-described embodiment but can be implemented in various modifications within a range not departing from the spirit of the invention. For example, the following modifications (1) to (3) are possible.

(1) In the above-described multi-display system according to the embodiment, a multi-display system in which projectors are used as a plurality of image display devices has been exemplified. However, a multi-display system in which direct-view-type image display devices are arranged may be employed. In the case of employing the direct-view-type image display devices, each of the direct-view-type image display devices has to have the image cut-out function. In the case of employing the direct-view-type image display devices, an overlapped region is not present between images displayed by the image display devices. Therefore, a multi-display system that performs display as shown in, for example, FIG. 4 can be configured.

(2) In the above-described multi-display system according to the embodiment, the plurality (four) of projectors PJ1 to PJ4 are connected in parallel to the image data distribution device 200, and composite image data from the PC 100 is distributed to the projectors PJ1 to PJ4. However, the projectors PJ1 to PJ4 may be multistage-connected (cascade-connected) without using the image data distribution device 200. In this case, although each of the projectors PJ1 to PJ4 has to have an external output terminal for outputting composite image data as it is from the former stage projector to the later stage projector, there is a projector originally including the external output terminal. Therefore, this modification can be easily implemented by using the projector.

(3) When a plurality of images displayed by a plurality of projectors are displayed so as to each have an overlapped region between adjacent images (refer to FIG. 5), the edge-blending process is performed through image processing in the embodiment. However, the edge-blending process through image processing and optical edge-blending means due to a light shielding plate that can adjust the brightness of the overlapped region can be used in combination.

The entire of Disclosure of Japanese Patent Application Nos: 2008-287427, filed Nov. 10, 2008 and 2009-022295, filed Feb. 3, 2009 are expressly incorporated by reference herein.

What is claimed is:

1. A multi-display system comprising:
a plurality of image display devices; and
an information processor adapted to output image data to the plurality of image display devices, wherein
the information processor includes
a composite image data generation unit adapted to combine partial image data corresponding to partial images to be displayed by individual ones of the plurality of image display devices to generate composite image data having a higher resolution than that of each of the image display devices, and
an image data output unit adapted to output the composite image data, and
each of the image display devices includes
an image data input unit adapted receive the composite image data generated by the information processor,
a partial image data generation unit adapted to cut out partial image data corresponding to an partial image to be displayed by the image display device from the composite image data, and
an image display unit adapted to display the partial image based on the partial image data cut out in the partial image data generation unit.

2. The multi-display system according to claim 1, wherein
the information processor includes a video card, and
the video card functions as the composite image data generation unit and the image data output unit.

3. The multi-display system according to claim 1, wherein
the respective resolutions in the horizontal and vertical directions of the composite image data are set to integral multiples of the resolutions in the horizontal and vertical directions of each of the image display devices.

4. The multi-display system according to claim 1, further comprising
an image data distribution device adapted to distribute in parallel the composite image data output from the information processor to each of the image display devices.

5. The multi-display system according to claim 1, wherein
the information processor applies image processing including image correction to the partial image data.

6. The multi-display system according to claim 5, wherein
the image correction applied to the partial image data includes image correction based on individual difference among the plurality of image display devices.

7. The multi-display system according to claim 6, wherein
the image correction based on the individual difference is correction regarding color.

8. The multi-display system according to claim 1, wherein
the plurality of image display devices are plurality of projectors, the plurality of projectors being disposed such that partial images to be displayed by the individual projectors are displayed in a state of being arranged on a screen.

9. The multi-display system according to claim 8, wherein
the information processor performs correction regarding shape of partial images to be displayed by the individual projectors on partial image data corresponding to the partial images.

10. The multi-display system according to claim 9, wherein,
the correction regarding shape of the partial images includes at least one of correction of display size of partial images displayed by the individual projectors and distortion correction of the partial images displayed by the individual projectors.

11. The multi-display system according to claim 8, wherein,
the information processor performs keystone correction on an entire image to be displayed on the screen.

12. The multi-display system according to claim 11, wherein,
the keystone correction is performed by correcting trapezoidal distortions of respective partial images displayed by the individual projectors by using correction parameters corresponding to the partial images displayed by the individual projectors.

13. The multi-display system according to claim 8, wherein,
partial images displayed by the individual projectors are related to one another, the partial images that are related to one another forming one large screen image.

14. The multi-display system according to claim 13, wherein,
partial images displayed by the individual projectors are displayed so as to each have an overlapped region between adjacent images, and
the information processor generates partial image data while considering the overlapped region for each of the projectors and generates composite image data obtained by combining the partial image data.

15. The multi-display system according to claim 14, wherein,
an edge-blending process is applied to the overlapped regions in the composite image data obtained by combining the partial image data.

16. An information processor in a multi-display system including a plurality of image display devices and the information processor adapted to output image data to the plurality of image display devices, comprising:
a composite image data generation unit adapted to combine partial image data corresponding to partial images to be displayed by individual ones of the plurality of image display devices to generate composite image data having a higher resolution than that of each of the image display devices; and
an image data output unit adapted to output the composite image data.

17. A method for processing image data in a multi-display system including a plurality of image display devices and an information processor adapted to output image data corresponding to images to be displayed by individual ones of the plurality of image display devices, the method comprising:
combining, by the information processor, partial image data corresponding to partial images to be displayed by the individual ones of the plurality of image display devices to generate composite image data having a higher resolution than that of each of the image display devices;
outputting, by the information processor, the composite image data;
receiving, by each of the image display devices, the composite image data generated by the information processor;
cutting out, by each of the image display devices, partial image data corresponding to a partial image to be displayed by the image display device from the composite image data; and
displaying, by each of the image display devices, the partial image based on the cut-out partial image data.
